(19) United States
(12) Patent Application Publication
(10) Pub. No.: US 2007/0017046 A1
(43) Pub. Date: Jan. 25, 2007

(54) Cleaner

(75) Inventor: Haruaki Kubo, Osaka (JP)

Correspondence Address: WOLF GREENFIELD & SACKS, PC, FEDERAL RESERVE PLAZA, 600 ATLANTIC AVENUE, BOSTON, MA, 02210-2206, US

(73) Assignee: Big Alpha Co., Inc., Hyogo (JP)

(21) Appl. No.: 11/187,623

(22) Filed: Jul. 22, 2005

(51) Int. Cl. B08B 9/00

(52) U.S. Cl. 15/104.05

(57) ABSTRACT

A cleaner having a simple configuration and capable of efficiently cleaning an inner surface defining a hollow portion of an object to be cleaned, wherein an outer boundary of a cross section of the hollow portion, which is taken perpendicularly to its central axis, forms an envelope of an approximate curved triangular shape, and a distance between any two parallel tangential lines in contact with the envelope is constant. The cleaner includes cleaning surfaces which can come into contact with the inner surface defining the hollow portion of the object to be cleaned, wherein the cleaning surfaces have a curvature radius equal to or less than the minimum curvature radius of the inner surface of the object when cleaning the inner surface.

### BACKGROUND

The present invention relates to a cleaner for cleaning an inner surface defining a hollow portion of an object to be cleaned, such as various kinds of mechanical parts, wherein an outer boundary of a cross section of the hollow portion, which is taken perpendicularly to its central axis, forms an envelope of an approximate curved triangular shape, and the distance between any two parallel tangential lines in contact with the envelope is constant.

There have been conventionally known various cleaners (cleaning tools) for cleaning hollow portions formed in various mechanical parts and the like. For example, there is a cleaner for cleaning an inner surface defining a hollow portion that is a parallel hole. The cleaner includes a cleaning tool main body that is composed of a pair of halved rod bodies, one of which is a fixed side and the other one of which is a movable side, that are obtained by cutting a rod body having a uniform cross section in half vertically at an angle tilted toward its central axis. This cleaner is configured by interposing, between the halved rod bodies, engaging means for causing the movable halved rod body to slidably engage with the fixed halve rod body, applying a scraper to the external surface of the respective halved rods throughout their entire length, so that the diameter of the cleaning tool main body can be reduced by sliding the movable halved body from a thin part thereof towards a thick part thereof by means of a slide operation portion provided on a base end portion of the movable halved body (see Japanese Patent Application Laid-Open No. H10-263492, for example).

Moreover, there is known a cleaner for cleaning the inner surface of a hollow portion of an object to be cleaned, wherein an outer boundary of a cross section of the hollow portion, which is taken perpendicularly to its central axis, forms an envelope of an approximate curved triangular shape, and the distance between any two parallel tangential lines in contact with the envelope is constant, and the inner surface is tapered from one end of the hollow portion toward the other end thereof. This cleaner has a plurality of inclined cleaning members so as to follow the tapered shape of the hollow portion. Each of these cleaning members has a spring-like supporting frame made of spring steels or the like, and a wiper made of a nonwoven fabric, sponge or the like and attached to the spring-like supporting frame, wherein the cleaning members are configured such that they are elastically deformed so as to be able to move between an inscribing circle that is in internal contact with the envelope of the hollow portion, and a circumscribing circle that is in external contact with the envelope of the hollow portion (see Japanese Patent Application Laid-Open No. 2001-150290, for example).

The hollow portion having the shape as described in Japanese Patent Application Laid-Open No. 2001-150290 is defined by an inner surface 101 shown in FIG. 7. Regarding the inner surface 101, the outer boundary of its cross section, which is taken perpendicularly to the central axis of a hollow portion 100, forms envelope E of an approximate curved triangular shape, and diameter r₁ of an inscribing circle Cᵢₙ, that is in internal contact with the envelop E is shorter than diameter r₂ of a circumscribing circle Cₒᵤₜ that is in external contact with the envelope curve E. In other words, a lift L is present between the inscribing circle Cᵢₙ and the circumscribing circle Cₒᵤₜ. Examples of such shape of a hollow portion include polygon file or the like which is defined in Deutsche Industrie Norman DIN 32711 (see Deutsche Industrie Normen DIN 32711).

However, an object of the cleaner described in Japanese Patent Application Laid-Open No. H10-263492 is to clean the inner surface defining the hollow portion that is a parallel hole, thus no consideration was taken regarding cleaning the inner surface of the hollow portion regarding which the outer boundary of the cross section as taken perpendicularly to its central axis forms the envelope of an approximate curved triangular shape, and in which the distance between any two parallel tangential lines in contact with the envelope is constant.

Moreover, in the cleaner described in Japanese Patent Application Laid-Open No. 2001-150290, the spring-like supporting frame is constituted by a base frame portion and a thin plate portion that is integrated with the base frame portion and whose transverse section is of a circular arc shape. The structure of this cleaner is complicated because it is configured to allow the thin plate portion to exhibit its spring elasticity and be thereby elastically deformed so that it can move between the inscribing circle in internal contact with the envelop of the inner surface defining the hollow portion, and the circumscribing circle in external contact with the envelope.

### SUMMARY

The present invention is contrived to improve these conventional cleaners described above. It is an object of the present invention to provide a cleaner having a simple structure, and capable of efficiently cleaning an inner surface defining a hollow portion of an object to be cleaned, wherein an outer boundary of a cross section of the hollow portion, which is taken perpendicularly to its central axis, forms an envelope of an approximate curved triangular shape, and the distance between any two parallel tangential lines in contact with the envelope is constant.

In order to achieve the above object, the present invention provides a cleaner for cleaning an inner surface defining a hollow portion of an object to be cleaned, wherein an outer boundary of a cross section of the hollow portion, which is taken perpendicularly to its central axis, forms an envelope of an approximate curved triangular shape, and a distance between any two parallel tangential lines in contact with the envelope is constant, and wherein the cleaner includes a cleaning portion having cleaning surfaces that can come into contact with the inner surface defining the hollow portion, and the cleaning surfaces have a curvature radius equal to or less than a minimum curvature radius of the inner surface when cleaning the inner surface defining the hollow portion.

The above-described cleaner has such a simple configuration so that the cleaning surfaces for cleaning the inner surface defining the hollow portion has a curvature radius equal to or less than the minimum curvature radius of the inner surface. However, even with that simple configuration, the cleaner can efficiently clean every corner of the inner surface of the cleaned object.

The cleaning surfaces can be placed at two positions apart from each other on the same straight line that intersects with the central axis. The distance between any two parallel tangential lines in contact with the envelope of the cross section taken perpendicularly to the central axis is constant. Accordingly, by placing the cleaning surfaces at two positions spaced apart from each other on the same straight lien that intersects with the central axis of the cleaner, the cleaning surfaces can be always brought into contact with the inner surface. Therefore, it is possible to clean the inner surface more efficiently.

Moreover, the cleaning surfaces may have a curvature radius of less than or equal to the minimum curvature radius of the inner surface defining the hollow portion. Specifically, the cleaning surfaces may have a curvature radius equal to or less than the minimum curvature radius of the inner surface even at times not cleaning the inner surface that defines the hollow portion.

In addition, in the cleaner according to the present invention, the cleaning portion may be made of an elastic member, and this cleaning portion can be inserted into the hollow portion in an elastically deformed state. With this configuration, the cleaning surfaces press the inner surfaces, whereby the inner surface can be cleaned efficiently. Further, the elasticity or thickness of the cleaning portion can be selected according to the shape of the hollow portion, so the cleaning surfaces can follow the inner surface even more easily. For example, even if the inner surface defining the hollow portion is taped in such a way that the width of the hollow portion narrows along the direction of its central axis toward a bottom of the hollow portion, the cleaning portion can be inserted deeply into the hollow portion by elastically deforming the cleaning portion of the cleaner.

In addition, the cleaning surfaces may be configured such that so as to have a curvature radius equal to or less than the minimum curvature radius of the inner surface defining the hollow portion by the elastic deformation described above when cleaning the inner surface.

In the cleaner according to the present invention, when the inner surface defining the hollow portion further is tapered in such a way that the width of the hollow portion narrows along the direction of its central axis toward the bottom of the hollow portion, the cleaning portion may be supported by a supporting portion that is tilted so as to complement the tapered inner surface. With such a configuration, it is possible to clean the inner surface defining the hollow portion even more efficiently by inserting the cleaning portion of the cleaner deeply into the hollow portion more easily.

As the outer boundary of the cross section of the hollow portion as taken perpendicularly to its central axis forms an envelope of an approximate curved triangular shape and the distance between any two parallel tangential lines in contact with the envelope is constant, the cleaning surfaces of the cleaner according to this invention come into contact with and clean the inner surface that defines the above-described hollow portion, and the cleaning surfaces have a curvature radius equal to or less than the minimum curvature radius of the inner surface when cleaning the inner surface. Therefore, with the above-described simple configuration, the cleaner can efficiently clean every corner of the inner surface.

### DESCRIPTION OF DRAWINGS

FIG. 1 is a side view of a cleaner according to Embodiment 1 of the present invention.

FIG. 2 is a plan view of the cleaner as viewed in the direction indicated with arrow A in FIG. 1.

FIG. 3 is a cross-sectional view of the cleaner according to Embodiment 1 of this invention as taken along line III-III of FIG. 1, which shows the state where the cleaner is inserted into a hollow portion of the object to be cleaned.

FIG. 4 is a side view of a cleaner according to Embodiment 2 of the present invention.

FIG. 5 is a plan view of the cleaner as viewed in the direction indicated with arrow A in FIG. 4.

FIG. 6 is a cross-sectional view of the cleaner according to Embodiment 2 of this invention as taken along line VI-IV of FIG. 4, which shows the state where the cleaner is inserted into a hollow portion of the object to be cleaned.

FIG. 7 is a plan view of the hollow portion into which the cleaner of the present invention is to be inserted.

### DETAILED DESCRIPTION

A cleaner according to preferred embodiments of the present invention is described below with reference to the drawings. It should be noted that the embodiments described hereinafter are examples for explaining the present invention, so the present invention is not limited to these embodiments. Therefore, the present invention can be implemented in various ways as long as they do not depart from the scope of the invention.

[Embodiment 1]

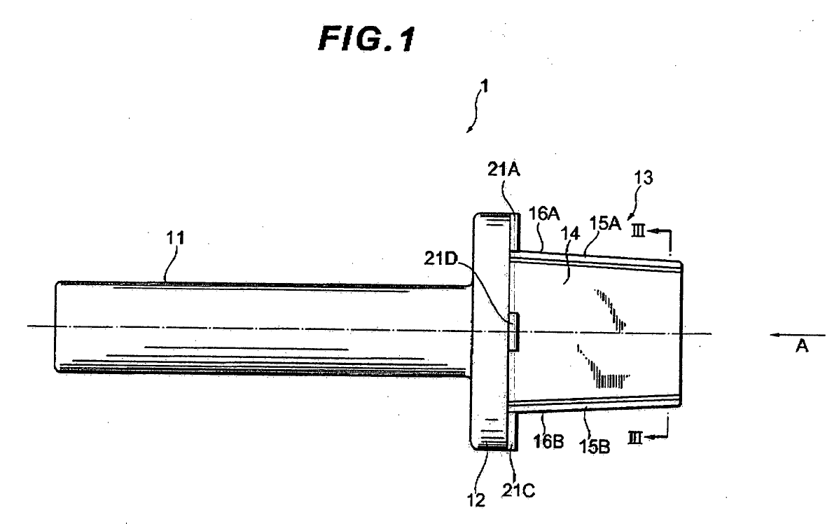

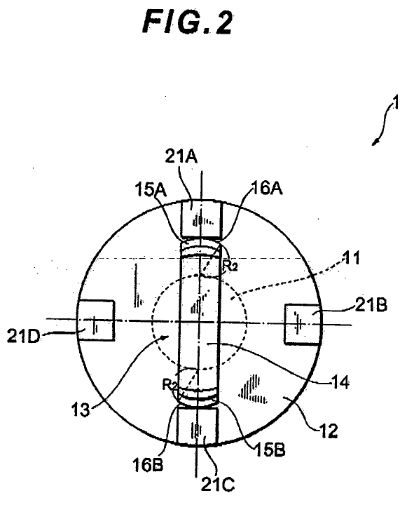

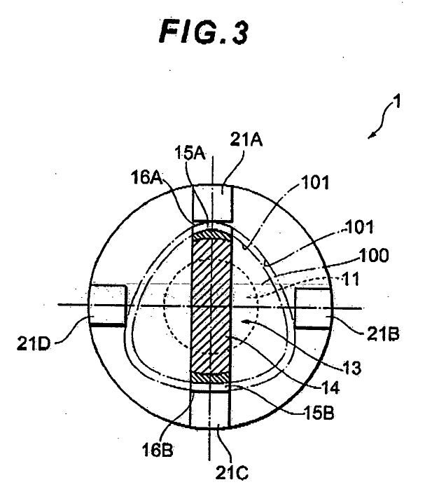

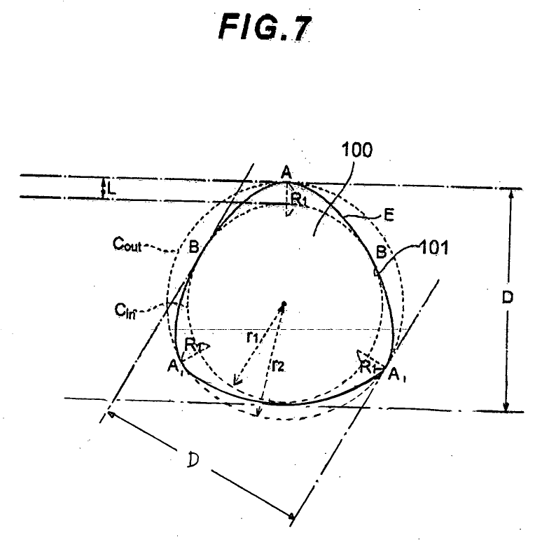

FIG. 1 is a side view of a cleaner according to Embodiment 1. FIG. 2 is a plan view of the cleaner as viewed in the direction indicated with arrow A in FIG. 1. FIG. 3 is a cross-sectional view of the cleaner according to Embodiment 1 of this invention as taken along line III-III of FIG. 1, which shows the state where the cleaner of Embodiment 1 of the present invention is inserted into a hollow portion. FIG. 7 is a plan view of the hollow portion into which the cleaner according to Embodiment 1 is to be inserted.

As shown in FIG. 7, an inner surface 101 that defines a hollow portion 100 into which a cleaner main body 13 of a cleaner 1 (see FIG. 1 through FIG. 3) according to Embodiment 1 is inserted, is formed in such a way that an outer boundary of a cross-section of the hollow portion 100, which is taken perpendicularly to its central axis, forms envelope E of an approximate curved triangular shape, and distance D between any two parallel tangential lines in contact with envelope E is constant. Further, diameter r₁ of an inscribing circle Cᵢₙ in internal contact with envelop E is shorter than diameter r₂ of a circumscribing circle Cₒᵤₜ in external contact with envelope E. Regarding this envelope E, the curvature radius of a part of envelope E that corresponds to a vertex of the approximate triangle, in other words the curvature radius of portion A which is in contact with the circumscribing circle Cₒᵤₜ, is a minimum curvature radius R₁, and portion B that is located between this portion A and an adjacent portion A, is in contact with the inscribing circle Cᵢₙ. The inner surface 101 is tapered in such a way that the width of the hollow portion 100 becomes narrower at its bottom than its open side.

As shown in FIG. 1 through FIG. 3, the cleaner 1 according to Embodiment 1 is designed to clean the inner surface 101 defining the hollow portion 100 by inserting the cleaner main body 13 into the hollow portion 100 and using cleaning surfaces 16 of the cleaner main body 13.

The cleaner 1 includes a substantially cylindrical rotatory operation holder 11; a flange 12 provided concentrically with the rotatory operation holder 11 at a top end of the rotatory operation holder 11; and the cleaner main body 13 which extends from the flange 12 and is inserted into the hollow portion 100.

On the external surface of an end face of the flange 12 on its top-end side, felt-like elastic members 21A, 21B, 21C and 21D are arranged at respective positions which are radially spaced apart by 90 degrees from one another. When the cleaner 1 is inserted into the hollow portion 100, these elastic members 21A, 21B, 21C and 21D can come into contact with the outer wall end face (not shown) of the object to be cleaned, which defines the hollow portion 100. Accordingly, when cleaning the inner surface 101 of the hollow portion 100 with the cleaner 1, the elastic members 21A, 21B, 21C, and 21D prevent the outer wall end face defining the hollow portion 100 and the end face of the flange 12 on its top-end side from being damaged by colliding with each other, and at the same time they can clean the outer wall end face.

The cleaner main body 13 includes: a supporting portion 14 that is disposed on the center line of the end face of the flange 12 and extends from the flange 12; and cleaning portions 15A and 15B provided respectively on opposing faces of the supporting portion 14 (the surfaces that face respectively the elastic members 21A and 21C provided on the flange 12).

A cross-section of the supporting portion 14 as taken perpendicularly to the central axis of the cleaner 1 is of an approximate rectangular shape. The short side of this rectangle, which comes closer to the bottom of the hollow portion 100 (this side is hereinafter called the “top-end side”) when the cleaner main body 13 is inserted into the hollow portion 100, has the same length as the short side placed at the rotatory operation holder 11 (this side is hereinafter called the “base-end side”). Further, the long side of the approximate rectangle on the top-end side is shorter than that on the base-end side. Therefore, both the side end faces of the supporting portion 14 that correspond to the short sides of the above-mentioned rectangular cross-section are tapered (see FIG. 1), thus it can be applied to the tapered shape of the hollow portion 100.

The cleaning portions 15A and 15B are provided on the opposing tapered faces of the supporting portion 14, and are made of, for example, felt. The external surfaces of the cleaning portions 15A and 15B are cleaning surfaces 16A and 16B that clean the inner surface 101 of the hollow portion 100. In the cleaning surfaces 16A and 16B, The cross-section of each cleaning surface 16A or 16B as taken perpendicularly to the central axis is curved (or forms a circular arc), and a curvature radius R₂ thereof is equal to or less than the minimum curvature radius R₁ of the inner surface 101 of the hollow portion 100. Moreover, the clear 1 is configured so that the distance between the cleaning surface 16A and the cleaning surface 16B is slightly longer than distance D (see FIG. 7) between two parallel tangential lines among the tangential lines in contact with envelope E of the hollow portion 100 to the extent that the cleaning surfaces 16A and 16B are positioned to enable cleaning of the inner surface 101 of the hollow portion 100.

The cleaning portions 15A and 15B are made of a material which can be elastically deformed. Therefore, even if the cleaning surfaces 168 are positioned with the distance between them slightly longer than distance D to the extent capable of cleaning the inner surface 101 of the hollow portion 100, the cleaning portions 15A and 15B come into contact with the inner surface 101 of the hollow portion 100 and are elastically deformed when inserted into the hollow portion 100, whereby the cleaning surfaces 16A and 16B are pressed against the inner surface 101. Therefore, the inner surface 101 can be cleaned efficiently.

It should be noted that the radial thicknesses or the elastic deformation ratio of the cleaning portions 15A and 15B may be determined arbitrarily. For example, if the cleaning portions 15A and 15B having a large elastic deformation ratio as that of a sponge are used to thicken the radial thickness thereof, it is possible to extend the applicability (or versatility) of the cleaner 1 to the hollow portion 100 of different sizes or shapes.

Next, when cleaning the inner surface 101 of the hollow portion 100 formed in, for example, a main spindle of a machine tool, using the cleaner 1 having the above configuration, the cleaner main body 13 of the cleaner 1 is first inserted into the hollow portion 100. At this moment, the cleaning portions 15A and 15B come into contact with the inner surface 101 of the hollow portion 100 and are elastically deformed, and the cleaning surfaces 16A and 16B are pressed against the inner surface 101. Furthermore, the curvature radius R₂ of the cleaning surfaces 16A and 16B is equal to or less than the minimum curvature radius R₁ of the inner surface 101 of the hollow portion 100, thus the cleaning surfaces 16A and 16B securely come into contact with the minimum curvature radius portion A of the inner surface 101. Accordingly, it is possible to clean the inner surface 101 thoroughly.

Moreover, as described above, regarding the inner surface 101 defining the hollow portion 100, the outer boundary of the cross section of the hollow portion 100, which is taken perpendicularly to its central axis, forms envelope E of an approximate curved triangular shape, and distance D between any two parallel tangential lines in contact with envelope E is constant (see FIG. 7). Accordingly, the cleaning surfaces 16A and 16B are constantly pressed against the inner surface 101 by simply rotating the cleaner 1. Therefore, the inner surface 101 can be cleaned efficiently.

Embodiment 1 describes a case in which the cleaning surfaces 16A and 16B are configured in such a way that their curvature radius R₂ is equal to or less than the minimum curvature radius R₁ of the inner surface 101 of the hollow portion 100. However, this invention is not limited to this configuration, and the curvature radius R₂ of the cleaning surfaces 16A and 16B may become equal to or less than the minimum curvature radius R₁ of the inner surface 101 after elastically deformed when cleaning the inner surface 101 defining the hollow portion 100. Specifically, for example, the curvature radius R₂ of the cleaning surfaces 16A and 16B before cleaning the inner surface 101 defining the hollow portion 100 (regular state) may be larger than the minimum curvature radius R₁ of the inner surface 101; However, after being elastically deformed when cleaning the inner surface 101, the curvature radius R₂ of the cleaning surfaces 16A and 16B should become equal to or less than the minimum curvature radius R₁ of the inner surface 101.

Moreover Embodiment 1 describes the tapered shape of the inner surface 101 of the hollow portion 100. However, this invention is not limited to this configuration, and the hollow portion 100 may be formed with a constant width from the base-end side toward the top-end side. In this case, the supporting portion 14 can be built perpendicularly with respect to the end face of the flange 12 on its top-end side.

Furthermore, Embodiment 1 describes a case in which the entire cleaner main body 13 is tapered by tapering the supporting portion 14. However, this invention is not limited to this configuration, and the cleaner main body 13 may be tapered by changing the thicknesses of the cleaning portions 15A and 15B.

In addition, the number of the elastic members 21A through 21D may be determined arbitrarily, and the number of the cleaner main bodies 13 may be determined as requested.

[Embodiment 2]

Next, a cleaner according to Embodiment 2 of the present invention is described with reference to the relevant drawings. It should be noted that in Embodiment 2, the same components as those described in Embodiment 1 are given the same reference numerals as used in Embodiment 1, thus the detailed explanation thereof is omitted.

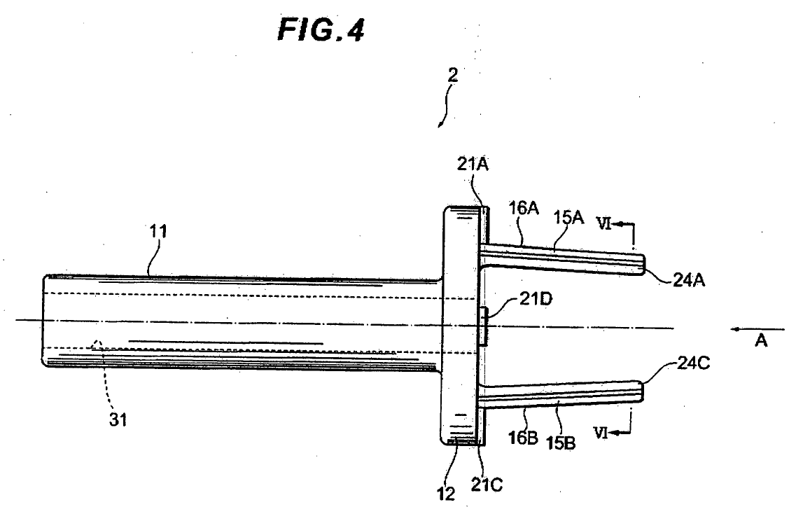

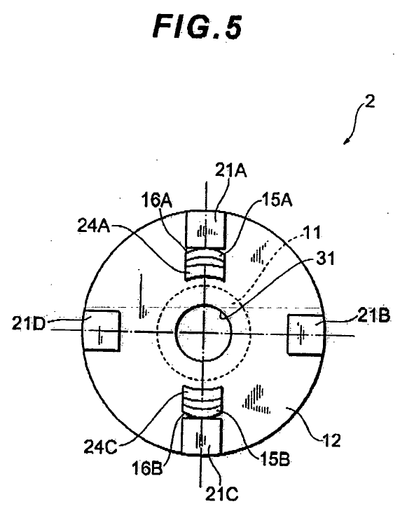

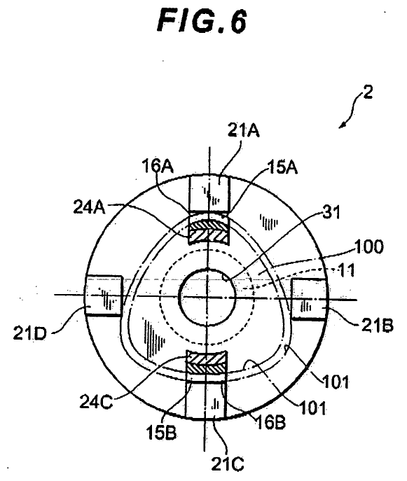

FIG. 4 is a side view of a cleaner according to Embodiment 2. FIG. 5 is a plan view of the cleaner as viewed from the direction indicated with arrow A in FIG. 4. FIG. 6 is a cross-sectional view of the cleaner according to Embodiment 2 of this invention as taken along line VI-VI of FIG. 4, which shows the state where the cleaner of Embodiment 2 is inserted into a hollow portion.

As shown in FIG. 4 through FIG. 6, the main differences between a cleaner 2 according to Embodiment 2 and the cleaner 1 according to Embodiment 1 are that a rotatory operation holder 11 is hollowed, and how supporting portions 24A and 24C are configured. Specifically, a substantially cylindrical hole 31 extending in the direction of the central axis is formed inside the rotatory operation holder 11. Further, the supporting portions 24A and 24C are formed by leaving a certain amount of thickness on both the tapered side faces of the supporting portion 14 described in Embodiment 1, and eliminating the inside of the supporting portion 14.

The cleaner 2 configured in the above-described manner has basically the same function as that of the cleaner 1. Moreover, it is also possible to realize the weight reduction by designing the rotatory operation holder 11 into a hollowed form, and eliminating the inside of the supporting portion 14 for the cleaner 1.

We claim:

1. A cleaner for cleaning an inner surface defining a hollow portion of an object to be cleaned, wherein an outer boundary of a cross section of the hollow portion, which is taken perpendicularly to its central axis, forms an envelope of an approximate curved triangular shape, and a distance between any two parallel tangential lines in contact with the envelope is constant,
wherein the cleaner comprises a cleaning portion having cleaning surfaces that can come into contact with the inner surface defining the hollow portion, and the cleaning surfaces have a curvature radius equal to or less than a minimum curvature radius of the inner surface when cleaning the inner surface defining the hollow portion.

2. The cleaner according to claim 1, wherein said cleaning surfaces are disposed at two positions apart from each other on the same straight line intersecting with the central axis.

3. The cleaner according to claim 1, wherein said cleaning surfaces have a curvature radius equal to or less than the minimum curvature radius of the inner surface defining the hollow portion.

4. The cleaner according to claim 1, wherein said cleaning surfaces are placed at two places apart from each other on the same straight line intersecting with the central axis, and have a curvature radius equal to or less than the minimum curvature radius of the inner surface defining the hollow portion.

5. The cleaner according to claim 1, wherein said cleaning portion is made of an elastic member, and can be inserted into the hollow portion in an elastically deformed state.

6. The cleaner according to claim 1, wherein said cleaning surface are placed at two positions apart from each other on the same straight line intersecting with the central axis, and said cleaning portion is made of an elastic member and can be inserted into the hollow portion in an elastically deformed state.

7. The cleaner according to claim 1, wherein said cleaning surfaces are placed at two positions apart from each other on the same straight line intersecting with the central axis, and have a curvature radius equal to or less than the minimum curvature radius of the inner surface defining the hollow portion, and said cleaning portion is made of an elastic member and can be inserted into the hollow portion in an elastically deformed state.

8. The cleaner according to claim 1, wherein said cleaning surfaces have a curvature radius equal to or less than the minimum curvature radius of the inner surface defining the hollow portion, and said cleaning portion is made of an elastic member and can be inserted into said hollow portion in an elastically deformed state.

9. The cleaner according to claim 5, wherein the curvature radius of said cleaning surfaces become equal to or less than the minimum curvature radius of the inner surface defining the hollow portion due to the elastic deformation when cleaning the inner surface.

10. The cleaner according to claim 1, wherein the inner surface defining the hollow portion is tapered in such a way that the width of the hollow portion narrows along the direction of its central axis toward a bottom of the hollow portion, and said cleaning portion is supported by a supporting portion that is inclined so as to complement the tapered inner surface.
